(19) United States
(12) Patent Application Publication
(10) Pub. No.: US 2025/0222798 A1
(43) Pub. Date: Jul. 10, 2025

(54) VEHICULAR CHARGE PORT DOOR ASSEMBLY WITH SLIDING SEAL

(71) Applicant: Magna Mirrors of America, Inc., Holland, MI (US)

(72) Inventor: Pierce Foster, Grand Haven, MI (US)

(21) Appl. No.: 19/011,714

(22) Filed: Jan. 7, 2025

Related U.S. Application Data
(60) Provisional application No. 63/618,943, filed on Jan. 9, 2024.

(51) Int. Cl. B60L 53/16; H01R 13/453; H01R 13/52

(52) U.S. Cl. CPC B60L 53/16; H01R 13/4534; H01R 13/5219

(57) ABSTRACT

A vehicular charge port closure system includes a cover panel disposed at a charge port of a vehicle and a sealing mechanism disposed at the charge port of the vehicle. With the cover panel in an opened position, the cover panel allows access to a charging connector of the charge port. The sealing mechanism is movable between an opened position where movable panels of the sealing mechanism are separated to provide a first opening to allow a charging wand to connect and disconnect from the charging connector of the charge port, and a closed position where the movable panels are moved towards one another as compared to the opened position to provide a second opening through which a charging wand is received. The movable panels engage the charging wand when the charging wand is connected to the charging connector of the charge port.

### CROSS REFERENCE TO RELATED APPLICATION

The present application claims the filing benefits of U.S. provisional application Ser. No. 63/618,943, filed Jan. 9, 2024, which is hereby incorporated herein by reference in its entirety.

### FIELD OF THE INVENTION

The present invention relates to a charge port or fuel port of a vehicle.

### BACKGROUND OF THE INVENTION

It is known to cover or conceal a fuel port of a vehicle or a charging port of an electric vehicle with a flap or door that is pivotable relative to the port between a closed position, where the flap is disposed over the port to cover and conceal the port, and an opened position, where the flap is pivoted away from the port to expose the port for receiving a fuel source or electrical connector of a charging station. Commonly, the flap is located at the side of the vehicle and is manually pivotable between the closed and opened positions.

### SUMMARY OF THE INVENTION

A vehicular charge port closure system includes a cover panel disposed at a charge port of a vehicle equipped with the vehicular charge port closure system. The cover panel is movable between (i) a closed position where the cover panel conceals a charge port of the vehicle and (ii) an opened position where the cover panel is moved away from the charge port to allow access to a charging connector of the charge port. The vehicular charge port closure system includes a sealing mechanism disposed at the charge port of the vehicle. The sealing mechanism is concealed by the cover panel with the cover panel in the closed position. With the cover panel in the opened position, the sealing mechanism is movable between (i) an opened position where movable panels of the sealing mechanism are separated to provide a first opening to allow a charging wand to connect and disconnect from the charging connector of the charge port and (ii) a closed position where the movable panels are moved towards one another as compared to the opened position to provide a second opening. The charging wand is received through the first opening and connects to the charging connector of the charge portion with the cover panel in the opened position and with the sealing mechanism in the opened position. With the cover panel in the opened position, and with the charging wand connected to the charging connector of the charge port, and with the sealing mechanism in the closed position, the charging wand is received through the second opening and the movable panels engage the charging wand.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vehicular electric charging system;

FIG. 2 is a perspective view of a sliding seal mechanism in an opened position;

FIG. 3 is a perspective view of the sliding seal mechanism in a closed position with a charging wand connected to a charging connector;

FIG. 4 is an exploded view of the sliding seal mechanism;

FIG. 5 is a perspective view of a left sliding door of the sliding seal mechanism;

FIG. 6 is an inner perspective view of the sliding seal mechanism in the opened position;

FIG. 7 is an outer perspective view of the sliding seal mechanism in the opened position;

FIG. 8 is an inner perspective view of a right sliding door of the sliding seal mechanism;

FIG. 9 is an inner perspective view of the left sliding door of the sliding seal mechanism.

FIG. 10 is an outer view of the sliding seal mechanism in the opened position;

FIG. 11 is an outer perspective view of the sliding seal mechanism in the opened position;

FIG. 12 is an enlarged view a rack and pinion assembly of the sliding seal mechanism; and

FIG. 13 is an inner view of the sliding seal mechanism in the opened position.

### DESCRIPTION OF THE PREFERRED EMBODIMENTS

A vehicular electric charging charge port opening system operates to open and/or close a power charge flap or panel of an electrically powered vehicle that covers a charging connector configured to electrically connect with an electrical connector of a charging wand to charge batteries of the electrically powered vehicle. The charging wand is a device that delivers electric power from an external power source to the batteries of the electrically powered vehicle via the charging connector. Aspects of the power charge flap described herein may also be suitable for use with a fuel port cover for covering a fuel filler port or opening of a vehicle that is configured to receive a nozzle that delivers fuel (e.g., gasoline) to a fuel tank of the vehicle via the fuel port.

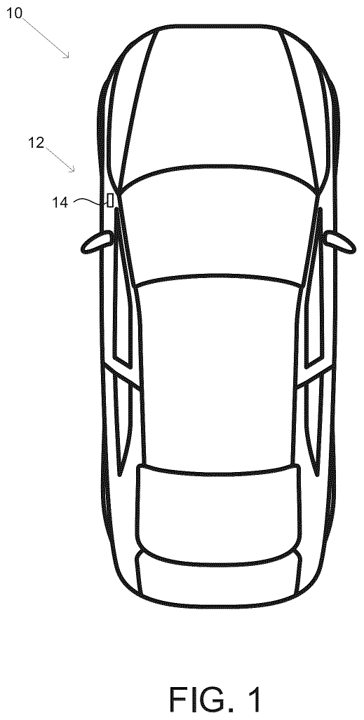

Referring now to the drawings and illustrative embodiments depicted therein, a vehicle 10 (e.g., an electric vehicle or EV, or a plug-in hybrid vehicle or PHEV) includes an electrical charging system or charge port 12 that includes a base portion or bracket and a cover panel or flap 14 (FIG. 1). For example, the cover panel 14 is pivotably mounted at the vehicle or a base portion 16 and has an outer surface that, when the cover panel 14 is in a closed position, corresponds with and/or is substantially flush with an outer surface of the exterior panel(s) of the vehicle 10 at and around the charge port 12 of the vehicle. When in the closed position, the cover panel 14 conceals a charging connector 18 of the charge port 12 that is configured or operable to electrically connect with an electrical connector or charging wand 20 of a charging station or system to charge batteries of the vehicle 10.

When the cover panel 14 moves to an opened position, the cover panel 14 moves relative to the base portion 16 and away from the side of the vehicle to reveal the charging connector 18 such that the electrical connector of the charging wand 20 (that is electrically connected to the charging station or system and that is configured or operable for electrically connecting to or plugging into the charging connector of the vehicle) can electrically connect to the charging connector 18. The cover panel 14 may be pivotable about a hinge or axis between the closed position and the opened position such that the cover panel 14 moves relative to the base portion 16 and away from the charge port and from the side of the vehicle to expose the charging connector 18. The charging wand 20, which is electrically connected to the charging station or system and has a mating configuration or shape for electrically connecting to or plugging into the charging connector 18, may be inserted into the charging connector 18 to establish an electrical connection. The charge port 12 includes a sliding seal mechanism 22 that provides a seal at the charging wand when the cover panel is opened and the charging wand is electrically connected to the charging connector 18, as discussed below. The sliding seal mechanism 22 may prevent or reduce the ingress of water, dust, debris, or other contaminants into the charge port 12 and the interface between the charging wand 20 and the charging connector 18.

As shown in FIG. 1, the charge port 12 is disposed along a side of the vehicle 10 and, when the cover panel 14 is in the closed position, the exterior surface of the panel 14 is substantially flush with and corresponds to the exterior surface of the vehicle 10 and/or the base portion at or surrounding the charge port 12. The charge port 12 may be disposed at any suitable position at the exterior of the vehicle. For example, the charge port 12 may be disposed at the front or rear fender or bumper of the vehicle. Optionally, the charge port 12 may be concealed behind an exterior feature of the vehicle 10, such as a manufacturer's emblem, a portion of a headlight or taillight, a license plate bracket, or the like, where the closure system enables movement of the exterior feature between the closed and opened positions. In some implementations, the exterior feature may be integrated with the cover panel 14 or may be separately movable from the cover panel 14. For example, the exterior feature may be attached to the cover panel 14 by a hinge, a magnet, a latch, or a snap-fit mechanism, or may be slidably or rotatably mounted on the vehicle body. The exterior feature may be moved manually by the user or automatically by an actuator in response to a user input or a sensor signal. The exterior feature may provide additional advantages such as improved aesthetics, security, and aerodynamics for the vehicle.

When the cover panel 14 is in the closed position, the cover panel 14 may at least partially compress a sealing element or gasket between a rear or interior side or an edge region of the cover panel 14 and the base portion 16 or side of the vehicle surrounding the charge port 12 to protect the connector portion and limit or preclude moisture and contaminants from entering the charge port 12 when the cover panel 14 is closed. For example, the sealing element may be disposed at the interior side of the cover panel 14 or at the base portion 16 and configured to at least partially circumscribe the connector when the cover panel 14 is closed. The sealing element may be made of any suitable material, such as rubber or other elastomeric material, plastic, foam, or the like, that can provide a resilient and flexible seal.

The cover panel 14 may be manually movable between the closed position and the opened position, or may be movable between the closed position and the opened position via operation of an electrically operable actuator, which may be electrically operated to move the cover panel in response to a user input. For example, the actuator may deploy the cover panel 14 in response to a user input at a key fob associated with the vehicle, a button or sensor at the exterior surface of the charge port 12 or vehicle, a button at the interior of the vehicle cabin, or a proximity sensor. The actuator may be a motor, a solenoid, a linear actuator, a pneumatic actuator, a hydraulic actuator, or any other suitable device that can generate a force or a motion to move the cover panel 14. The actuator may be controlled by a controller that receives the user input and sends a signal to the actuator to move the cover panel 14. The controller may also receive feedback from a sensor that detects the position or the status of the cover panel 14 and adjusts the signal accordingly. The controller may also communicate with other systems of the vehicle, such as the charging system, the locking system, the lighting system, or the display system, to coordinate the operation of the cover panel 14 with other functions of the vehicle.

When actuated, the actuator (such as an electrically operable motor of the actuator) operates to move the cover panel 14 from the closed position to the opened position and from the opened position to the closed position. The cover panel may move relative to the base portion 16 or vehicle in any suitable manner, such as in a swinging or pivoting motion inward or outward from the vehicle (such as upward or sideward from the vehicle), or in a sliding motion along the surface of the vehicle (such as along an interior surface of the body panel or an outer surface of the body panel), or in a rotating motion about a pivot axis substantially perpendicular to the surface of the vehicle (such as along the interior surface or outer surface of the body panel), and the like. The movement of the cover panel 14 may also be synchronized with the movement of the exterior feature, if any, that conceals the charge port 12, such that the exterior feature moves in the same or opposite direction as the cover panel 14, or remains stationary while the cover panel 14 moves. For example, the cover panel and actuator may utilize characteristics of the charge ports and charging systems described in U.S. Publication Nos. US-2023-0191926; US-2024-0109409; US-2024-0294077; US-2024-0328229 and/or US-2024-0246409, which are hereby incorporated herein by reference in their entireties.

Since the cover panel 14 conceals the charge port 12 in the closed position, the cover panel 14 is required to be in the opened position to allow for charging. When in the opened position, the cover panel 14 does not conceal the charge port 12 such that the charge port 12 is exposed to the surrounding environment of the vehicle 10. For example, even when the charging wand 20 is electrically connected to the charging connector 18, the interface between the charging wand 20 and the charging connector 18 and the area around the charging connector 18 are still exposed to the surrounding environment. In some scenarios, such as during inclement weather (e.g., rain, snow, etc.), this exposure may adversely impact the charging connector 18 and/or the charging wand 20. Thus, even though the cover panel 14 conceals the charge port 12 while the cover panel 14 is in the closed position, the cover panel 14 does not conceal or otherwise protect the charge port 12 while the cover panel 14 is in the opened position.

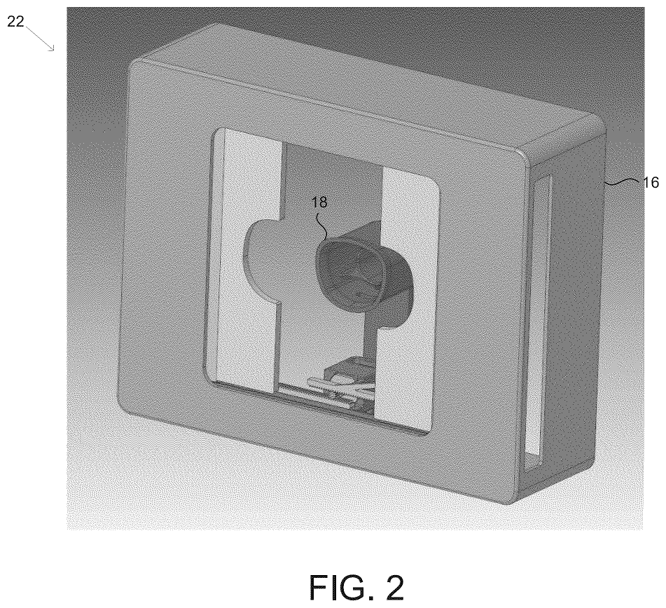

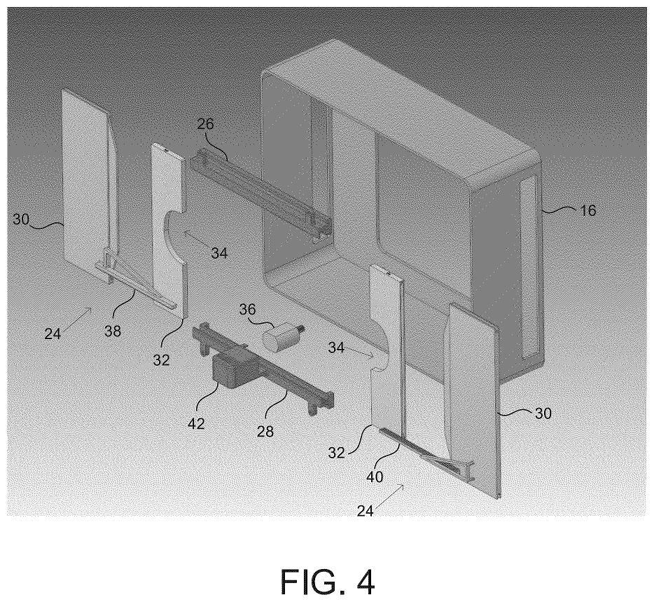

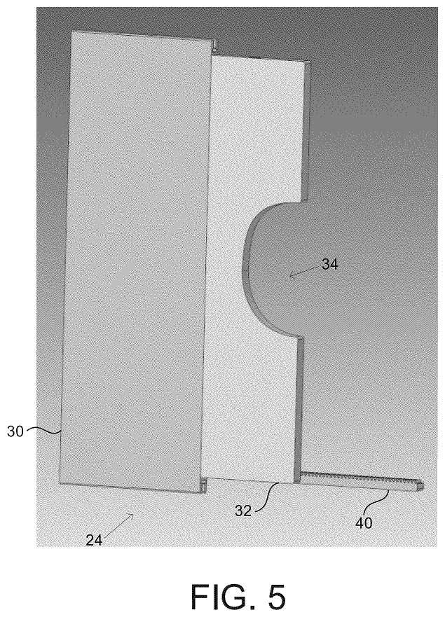

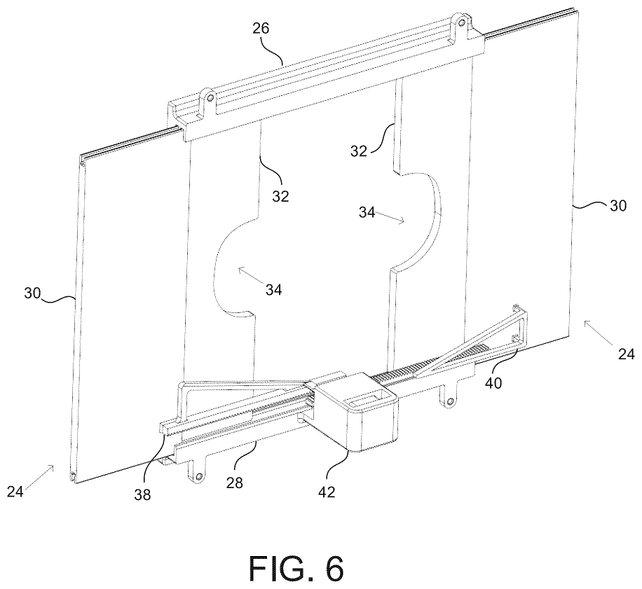

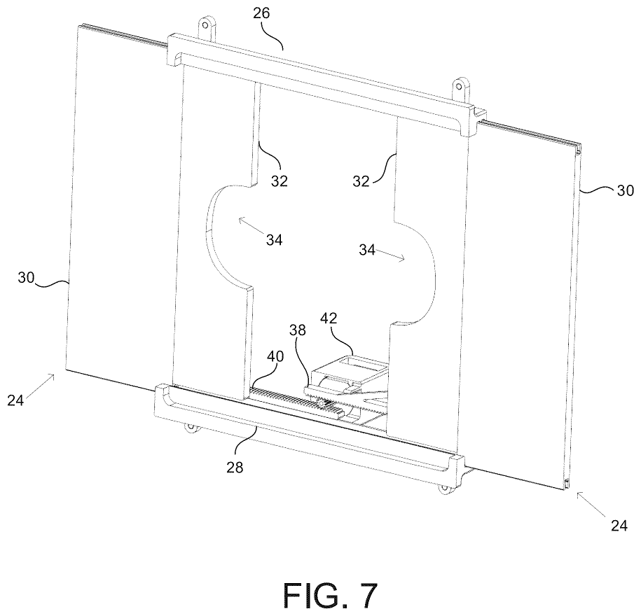

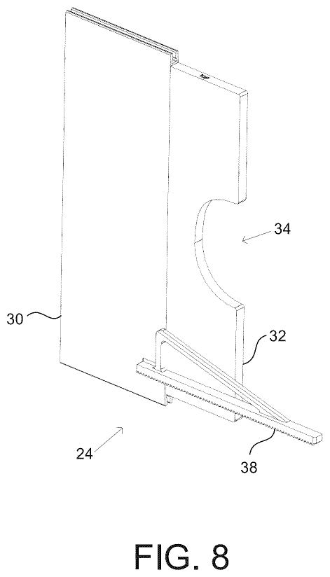

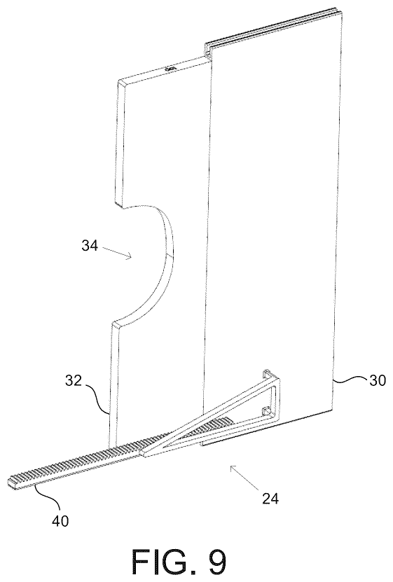

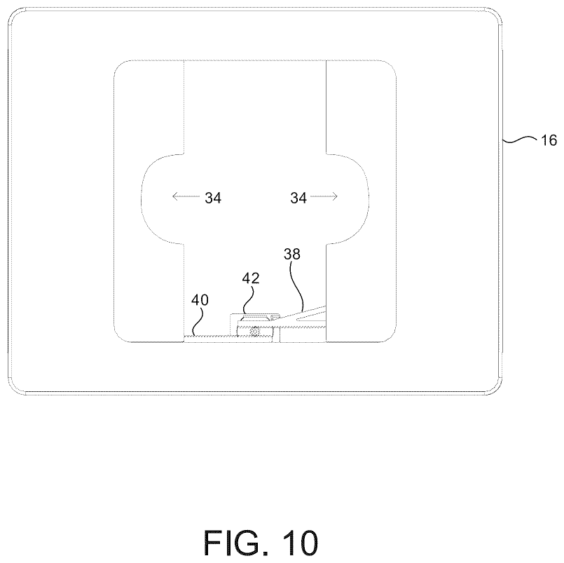

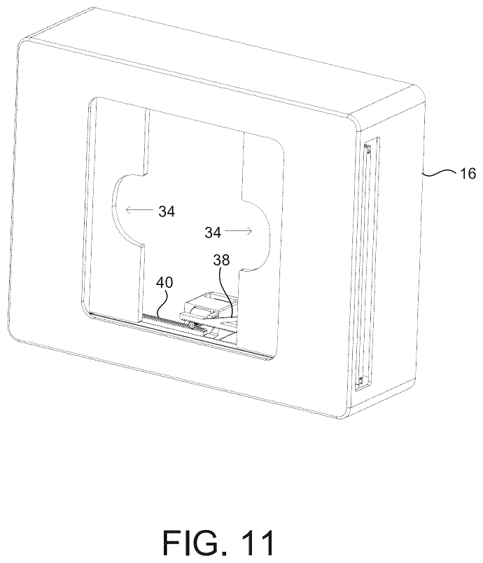

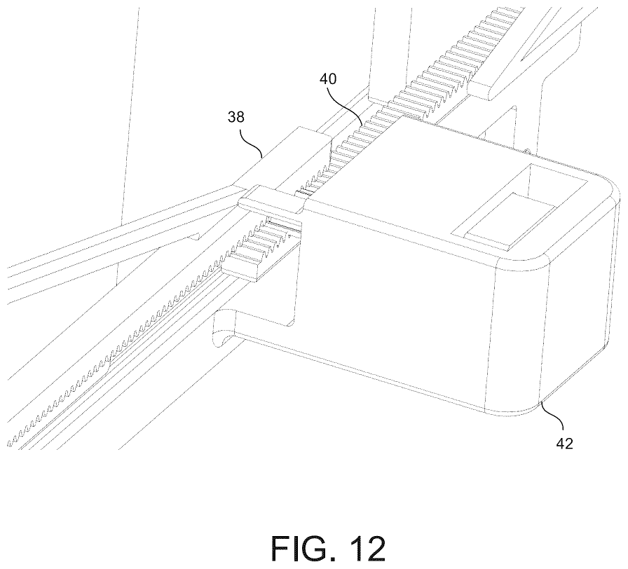

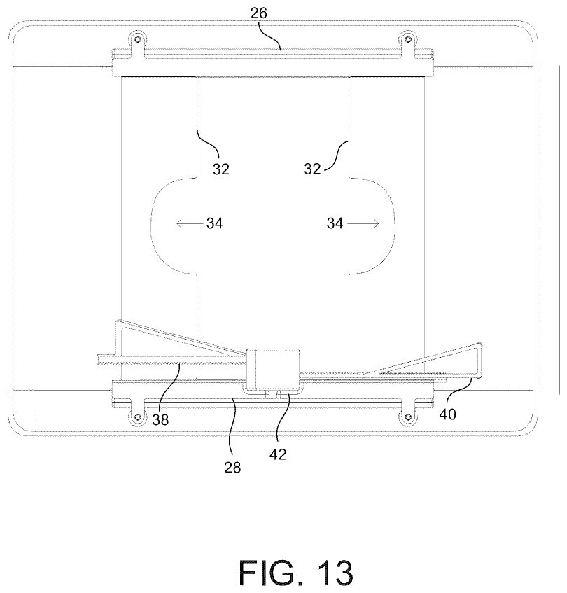

Referring to FIGS. 2-13 the sliding seal mechanism 22 is disposed at the vehicle 10 and located behind the cover panel 14. When the cover panel 14 is in the closed position, the cover panel 14 conceals the sliding seal mechanism 22, and when the cover panel 14 is in the opened position, the cover panel 14 is moved away from the charge port 12 to allow access to the sliding seal mechanism 22 and the charging connector 18. The sliding seal mechanism 22 operates to conceal/protect the charge port 12 when the cover panel 14 is in the opened position and the charging wand 20 is connected to the charging connector 18. The sliding seal mechanism 22 includes a housing 16, sliding doors (i.e., movable panels) 24, an upper rail 26, and a lower rail 28. The sliding seal mechanism 22 may be attached at the vehicle at the charge port 12. For example, the housing 16 of the sliding seal mechanism 22 may be attached to the base portion of the charge port 12.

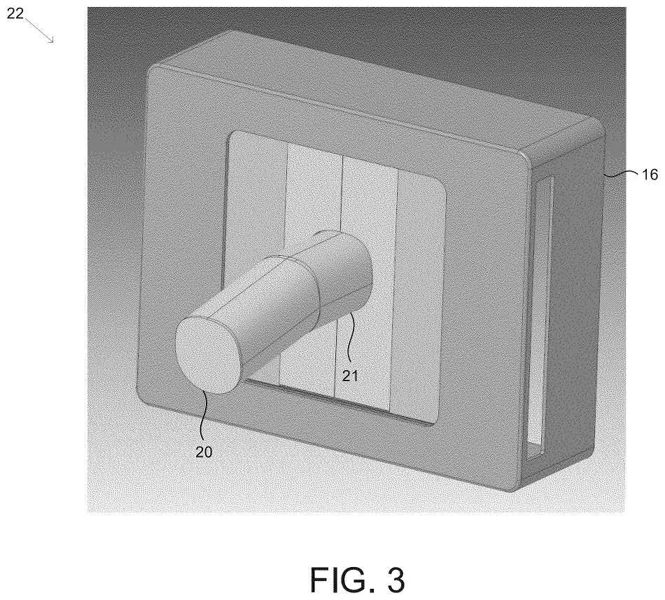

The sliding seal mechanism 22 is movable between a closed position and an opened position. As shown in FIG. 3, with the sliding seal mechanism 22 in the closed position, the sliding doors 24 define a second opening through which the charging wand 20, including a neck portion 21 of the charging wand 20, is received and engage the charging wand 20. The neck portion 21 of the charging wand 20 is a relatively narrow and elongated section that connects a head portion of the charging wand 20 to a handle portion of the charging wand 20. The head portion of the charging wand 20 is a relatively wide and flat section that contains electrical contacts for transmitting power to the charging connector 18 of the charge port 12. The handle portion of the charging wand 20 is a relatively thick and curved section that allows a user to grasp and manipulate the charging wand 20. More specifically, the sliding doors 20 engage the neck portion 21 of the charging wand 20 when the charging wand 20 is connected to the charging connector 18 of the charge port 12 as the head portion of the charging wand 20 is aligned with and connected to the charging connector 18. Put another way, the sliding doors 24 form a seal around the neck portion 21 of the charging wand 20.

Thus, the seal between the sliding doors 24 and the neck portion 21 of the charging wand 20 cooperatively conceal the charging connector 18 of the charge port 12, and the area surrounding the charging connector 18, from the environment surrounding the vehicle during charging of the vehicle battery. Advantageously, the sliding seal mechanism 22 protects the interface between the charging connector 18 and the charging wand 20 from the environment surrounding the vehicle 10 (e.g., inclement weather) while the vehicle 10 is charging. Thus, the second opening may be substantially similar in size and shape to that of a typical neck portion 21 of a charging wand 20. The second opening may be smaller in size than a typical head portion of the charging wand 20 such that the charging wand 20 is unable to be connected to, or removed from, the charging connector 18 unless the sliding seal mechanism 22 is moved to the opened position. Notably, the second opening does not completely conceal the charging connector 18 when the charging wand 20 is not connected to the charging connector, but rather leaves a gap between the sliding doors 24 which is not large enough for the head portion of the charging wand 20 to pass through.

As shown in FIG. 2, with the sliding seal mechanism 22 in the opened position, the sliding doors 24 define a first opening that is larger than the second opening to allow the charging wand 20 to connect to and disconnect from the charging connector 18 of the charge port 12. That is, when the sliding seal mechanism 22 is in the opened position, the first opening is sufficient in size to allow the charging wand 20, including the neck portion 21 and the head portion of the charging wand 20, to connect to, or disconnect from, the charging connector 18. When the sliding seal mechanism 22 is in the opened position and the charging wand 20 is connected to the charging connector 18, the movable panels 24 do not engage the neck portion 21 of the charging wand 20 and are sufficiently spaced apart to allow connection and disconnection of the charging wand to the charging connector without the movable panels contacting the charging wand. After the charging wand 20 is connected to, or disconnected from, the charging connector 18, the sliding seal mechanism 22 may return to the closed position. When the sliding seal mechanism 22 is in the closed position, the sliding seal mechanism 22 may limit or preclude the charging wand 20 from connecting to, or disconnecting from, the charging connector 18.

In some examples, the sliding seal mechanism 22 includes two sliding doors 24. The sliding doors 24 move along the upper rail 26 and the lower rail 28. More specifically, an upper edge region of the sliding doors 24 engages and moves along the upper rail 26 and a lower edge region of the sliding doors 24 engages and moves along the lower rail 28. Thus, the upper rail 26 and the lower rail 28 guide the sliding doors 24 moving between the closed position and the opened position.

Each sliding door 24 includes a rigid or substantially rigid component or element or portion 30 that is attached to a flexible or conformable component or element or portion 32. Each flexible component 32 (e.g., an element or panel formed of a rubber or elastomeric material) includes a cut-away portion 34 that mirrors the cut-away portion from the other sliding door 24. In the example shown, the cut-away portion 34 of the left sliding door 24 includes a half-circle shape that mirrors a half-circle shape of the cut-away portion 34 of the right sliding door 24. Thus, in this example, when the sliding seal mechanism 22 is in the closed position, the cut-away portions 34 of the sliding doors 24 form a circular shaped second opening. The size and/or shape of the second opening may be the same or substantially similar to the neck portion 21 of the charging wand 20 thereby forming a seal with the neck portion 21 of the charging wand 20 when the charging wand 20 is connected to the charging connector 18. The flexible components of the sliding doors may be formed so that the size and/or shape of the second opening is smaller than a diameter or size of a neck portion of a typical charging wand, such that the flexible components may flex and conform to the neck portion of the charging wand and seal against the charging wand when the sliding doors are closed with the charging wand connected to the charge port. An edge region of the cut-away portion 34 may include a sealing element or gasket to limit or preclude moisture and contaminants from entering the charging connector 18 of the charge port 12.

To move the sliding seal mechanism 22 between the closed position and the opened position, the sliding seal mechanism includes a rack and pinion assembly. The rack and pinion assembly is electrically operable to move the sliding seal mechanism 22 between the closed position and the opened position. The rack and pinion assembly comprises a pinion 36, a first rack 38 attached to one of the sliding doors, and a second rack 40 attached the other one of the sliding doors 24. The pinion 36 is disposed within a cradle 42 of the bottom rail 28. The pinion 36 includes a plurality of teeth that engage corresponding teeth of the first and second racks 38, 40. Moreover, the pinion 36 may be coupled to a motor such that the motor operates to rotate the pinion 36. The rotational movement of the pinion 36 causes teeth of the pinion 36 to engage the teeth of the first and second racks 38, 40. As such, the rotation of the pinion 36 causes both the first and second racks 38, 40 to move (i.e., translate) in tandem inwards or outwards along a horizontal translation axis. The upper rail 26 and the lower rail 28 may extend along and define the horizontal translation axis. That is, the upper rail 26 and the lower rail 28 engage the sliding doors 24 to guide the sliding doors 24 along the horizontal translation axis.

In the illustrated embodiment, the first rack 38 is attached to the rigid component 30 of one of the sliding doors 24 and the second rack 40 is attached to the rigid component 30 of the other one of the sliding doors 24. In some examples, the teeth of the first rack 38 engage a top side of the pinion 36 and the teeth of the second rack 40 engage a bottom side of the pinion 36. In these examples, the teeth of the first rack 38 face upwardly to engage the teeth on the top side of the pinion 36 and the teeth of the second rack 40 face downwardly to engage the teeth on the bottom side of the pinion 36. In other examples, the teeth of the first rack 38 engage the bottom side of the pinion 36 and the teeth of the second rack 40 engage the top side of the pinion 36.

Thus, as the pinion 36 rotates in a first direction, the first and second racks 38, 40 move (i.e., translate) inwardly along the horizontal translation axis. Conversely, as the pinion 36 rotates in a second direction opposite the first direction, the first and second racks 38, 40 move (i.e., translate) outwardly along the horizontal translation axis. Since the first and second racks 38, 40 are attached to the sliding doors 24, the sliding doors 24 also move along the horizontal translation axis with the first and second racks 38, 40. The motor of the rack and pinion assembly may operate in response to user input.

For example, the user input may be from a key fob associated with the vehicle, a button or sensor at the exterior surface of the charge port 12 or vehicle, or a button at the interior of the vehicle cabin. Optionally, the motor may operate in response to a sensor that detects the presence or the absence of the charging wand 20 at the charge port 12, and automatically moves the sliding seal mechanism 22 to the opened position or the closed position accordingly. Optionally, the motor may operate in response to a timer or a schedule that moves the sliding seal mechanism 22 to the opened position or the closed position at predetermined intervals or times. Optionally, the motor may operate in response to a signal from the controller of the cover panel 14 or other systems of the vehicle, such as the charging system, the locking system, the lighting system, or the display system, to coordinate the operation of the sliding seal mechanism 22 with other functions of the vehicle. For example, the motor may operate such that the sealing mechanism 22 automatically moves toward the opened position when the cover panel 14 is opened and automatically moves toward the closed position when the cover panel 14 is closed. Additionally or alternatively, the motor may operate such that the sealing mechanism 22 automatically moves toward the opened position when a vehicle charge state exceeds a threshold. For example, the sealing mechanism 22 may automatically open when the charge state of the vehicle batteries exceeds a 90% charge state. Optionally, the sliding doors may be manually movable, whereby a user may slide one of the doors toward the opened position or toward the closed position, whereby the other door is correspondingly moved toward the opened position or toward the closed position.

Thus, the sliding seal mechanism provides a seal at and around the charging wand to limit or preclude intrusion of dirt, water, moisture or the like into the charge port area when the charge port cover is opened for charging the vehicle battery. The sliding seal mechanism may automatically move to the opened position when the charge port cover is opened, and then may automatically move toward the closed position when the charging wand is electrically connected to the charge port. Optionally, the sliding seal mechanism may be manually moved by a user.

Optionally, the actuator may utilize aspects of the actuators described in U.S. Publication Nos. US-2024-0246485; US-2024-0239267; US-2024-0035318; US-2023-0027125 and/or US-2022-0341226, which are hereby incorporated herein by reference in their entireties.

The charge ports described herein may be illuminated via any suitable means, and may utilize aspects of the charge ports and systems described in U.S. Pat. No. 8,317,376, which is hereby incorporated herein by reference in its entirety. The vehicle may include various indicators to indicate the charge level of the vehicle, such as by utilizing aspects of the systems described in U.S. Pat. No. 10,746,575 and/or U.S. Publication No. US-2021-0129757, which are hereby incorporated herein by reference in their entireties.

Optionally, the system and cover may operate to provide autonomous charging and may open the cover panel and pivot or move the charging connector responsive to determination of presence of the charging wand, and may control movement of the charging wand to guide the wand into electrical connection with the charging connector when the panel is opened and the connector is pivoted or moved to its charging position. The system may provide a passive way of charging electric vehicles (or plug-in hybrid vehicles or PHEVs) assisted by ultra-wideband (UWB) time of flight distance measurements (which may be made via processing of data captured by one or more time of flight sensors and/or transmitters disposed at the vehicle charge port and/or sensing or communicating with the charging wand), such as by utilizing aspects of the systems described in U.S. publication No. US-2023-0133911, which is hereby incorporated herein by reference in its entirety. A communication gateway in communication with a PCF may automatically establish a connection with the charging station the electric vehicle is parked at. This automates the process of charging the vehicles (i.e., reduces or eliminates human intervention). The system allows for the charging station plug of the charging station to be guided to the charging socket of the electric vehicle using range and vector communication supplied by a UWB antenna system.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular charge port closure system, the vehicular charge port closure system comprising:
a cover panel disposed at a charge port of a vehicle equipped with the vehicular charge port closure system, wherein the cover panel is movable between (i) a closed position where the cover panel conceals a charge port of the vehicle and (ii) an opened position where the cover panel is moved away from the charge port to allow access to a charging connector of the charge port;
a sealing mechanism disposed at the charge port of the vehicle, wherein, with the cover panel in the closed position, the sealing mechanism is concealed by the cover panel;
wherein, with the cover panel in the opened position, the sealing mechanism is movable between (i) an opened position where movable panels of the sealing mechanism are separated to provide a first opening to allow a charging wand to connect and disconnect from the charging connector of the charge port and (ii) a closed position where the movable panels are moved towards one another as compared to the opened position to provide a second opening;
wherein, with the cover panel in the opened position, and with the sealing mechanism in the opened position, the charging wand is received through the first opening and connects to the charging connector of the charge port; and
wherein, with the cover panel in the opened position, and with the charging wand connected to the charging connector of the charge port, and with the sealing mechanism in the closed position, the charging wand is received through the second opening and the movable panels engage the charging wand.

2. The vehicular charge port closure system of claim 1, wherein the sealing mechanism further comprises a rack and pinion assembly that is electrically operable to move the sealing mechanism between the closed position and the opened position.

3. The vehicular charge port closure system of claim 2, wherein the rack and pinion assembly comprises a pinion, a first rack attached to one of the movable panels, and a second rack attached to the other one of the movable panels.

4. The vehicular charge port closure system of claim 3, wherein the first rack engages with an upper portion of the pinion and the second rack engages with a lower portion of the pinion.

5. The vehicular charge port closure system of claim 3, wherein, as the pinion rotates, the pinion causes the movable panels to translate inwardly or outwardly along a horizontal translation axis.

6. The vehicular charge port closure system of claim 1, wherein each movable panel comprises a flexible sealing element at an inward end region of the movable panel.

7. The vehicular charge port closure system of claim 6, wherein the flexible sealing element of each movable panel comprises a cut-away portion that mirrors the cut-away portion of the other movable panel.

8. The vehicular charge port closure system of claim 6, wherein the second opening formed by the flexible sealing elements has a smaller cross dimension than a diameter of a neck portion of the charging wand, and wherein, with the charging wand connected to the charging connector of the charge port, and with the sealing mechanism in the closed position, the flexible sealing elements conform to the neck portion of the charging wand to seal the movable panels at the charging wand.

9. The vehicular charge port closure system of claim 1, wherein the sealing mechanism further comprises an upper rail and a lower rail, and wherein the upper rail engages an upper edge region of the movable panels and the lower rail engages a lower edge region of the movable panels.

10. The vehicular charge port closure system of claim 1, wherein, with the charging wand connected to the charging connector of the charge port and with the sealing mechanism in the closed position, the movable panels and the charging wand cooperatively conceal the charge port of the vehicle.

11. The vehicular charge port closure system of claim 1, wherein the sealing mechanism automatically moves toward the opened position when the cover panel is opened.

12. The vehicular charge port closure system of claim 1, wherein the sealing mechanism automatically moves toward the closed position when the charging wand is electrically connected to the charge port.

13. The vehicular charge port closure system of claim 1, wherein the sealing mechanism automatically moves toward the opened position when a vehicle charge state exceeds a threshold.

14. The vehicular charge port closure system of claim 1, wherein the sealing mechanism automatically moves toward the closed position when the cover panel is closed.

15. The vehicular charge port closure system of claim 1, wherein, with the cover panel in the opened position, and with the sealing mechanism in the opened position, and with the charging wand received through the first opening and connected to the charging connector of the charge port, the movable panels do not engage the charging wand.

16. A vehicular charge port closure system, the vehicular charge port closure system comprising:
a cover panel disposed at a charge port of a vehicle equipped with the vehicular charge port closure system, wherein the cover panel is movable between (i) a closed position where the cover panel conceals a charge port of the vehicle and (ii) an opened position where the cover panel is moved away from the charge port to allow access to a charging connector of the charge port;
a sealing mechanism disposed at the charge port of the vehicle, wherein, with the cover panel in the closed position, the sealing mechanism is concealed by the cover panel;
wherein, with the cover panel in the opened position, the sealing mechanism is movable between (i) an opened position where movable panels of the sealing mechanism are separated to provide a first opening to allow a charging wand to connect and disconnect from the charging connector of the charge port and (ii) a closed position where the movable panels are moved towards one another as compared to the opened position to provide a second opening;
wherein, with the cover panel in the opened position, and with the sealing mechanism in the opened position, the charging wand is received through the first opening and connects to the charging connector of the charge port;
wherein, with the cover panel in the opened position, and with the charging wand connected to the charging connector of the charge port, the sealing mechanism automatically moves toward the closed position and the charging wand is received through the second opening with the movable panels engaging the charging wand; and
wherein the sealing mechanism automatically moves toward the opened position when the cover panel is opened.

17. The vehicular charge port closure system of claim 16, wherein the sealing mechanism further comprises a rack and pinion assembly that is electrically operable to move the sealing mechanism between the closed position and the opened position.

18. The vehicular charge port closure system of claim 17, wherein the rack and pinion assembly comprises a pinion, a first rack attached to one of the movable panels, and a second rack attached to the other one of the movable panels.

19. The vehicular charge port closure system of claim 18, wherein the first rack engages with an upper portion of the pinion and the second rack engages with a lower portion of the pinion.

20. The vehicular charge port closure system of claim 18, wherein, as the pinion rotates, the pinion causes the movable panels to translate inwardly or outwardly along a horizontal translation axis.

21. A vehicular charge port closure system, the vehicular charge port closure system comprising:
a cover panel disposed at a charge port of a vehicle equipped with the vehicular charge port closure system, wherein the cover panel is movable between (i) a closed position where the cover panel conceals a charge port of the vehicle and (ii) an opened position where the cover panel is moved away from the charge port to allow access to a charging connector of the charge port;
a sealing mechanism disposed at the charge port of the vehicle, wherein, with the cover panel in the closed position, the sealing mechanism is concealed by the cover panel;
wherein, with the cover panel in the opened position, the sealing mechanism is movable between (i) an opened position where movable panels of the sealing mechanism are separated to provide a first opening to allow a charging wand to connect and disconnect from the charging connector of the charge port and (ii) a closed position where the movable panels are moved towards one another as compared to the opened position to provide a second opening;
wherein, with the cover panel in the opened position, and with the sealing mechanism in the opened position, the charging wand is received through the first opening and connects to the charging connector of the charge port;
wherein, with the cover panel in the opened position, and with the charging wand connected to the charging connector of the charge port, and with the sealing mechanism in the closed position, the movable panels and the charging wand cooperatively conceal the charge port of the vehicle, the charging wand is received through the second opening, and the movable panels engage the charging wand; and
wherein, with the cover panel in the opened position, and with the sealing mechanism in the opened position, and with the charging wand received through the first opening and connected to the charging connector of the charge port, the movable panels do not engage the charging wand.

22. The vehicular charge port closure system of claim 21, wherein the sealing mechanism further comprises a rack and pinion assembly that is electrically operable to move the sealing mechanism between the closed position and the opened position.

23. The vehicular charge port closure system of claim 22, wherein the rack and pinion assembly comprises a pinion, a first rack attached to one of the movable panels, and a second rack attached to the other one of the movable panels.

24. The vehicular charge port closure system of claim 23, wherein the first rack engages with an upper portion of the pinion and the second rack engages with a lower portion of the pinion.

25. The vehicular charge port closure system of claim 23, wherein, as the pinion rotates, the pinion causes the movable panels to translate inwardly or outwardly along a horizontal translation axis.

26. The vehicular charge port closure system of claim 21, wherein the sealing mechanism automatically moves toward the opened position when the cover panel is opened.

27. The vehicular charge port closure system of claim 21, wherein the sealing mechanism automatically moves toward the closed position when the charging wand is electrically connected to the charge port.
